(19) United States
(12) Patent Application Publication
(10) Pub. No.: US 2018/0159894 A1
(43) Pub. Date: Jun. 7, 2018

(54) AUTOMATIC THRESHOLD LIMIT CONFIGURATION FOR INTERNET OF THINGS DEVICES

(71) Applicant: Cisco Technology, Inc., San Jose, CA (US)

(72) Inventors: K. Tirumaleswar Reddy, Bangalore (IN); Prashanth Patil, Mountain View, CA (US); Daniel G. Wing, San Jose, CA (US)

(21) Appl. No.: 15/366,354

(22) Filed: Dec. 1, 2016

(51) Int. Cl. H04L 29/06

(52) U.S. Cl. CPC H04L 63/1458; H04L 2463/141; H04L 63/02; H04L 63/1416

(57) ABSTRACT

Presented herein are techniques for mitigating a distributed denial of service attack. A method includes, at a network security device, such as a firewall, monitoring network traffic, flowing through the firewall, destined for a network device, determining whether the network traffic is below a predetermined amount, while the network traffic is below the predetermined amount, sending to the network device a plurality of probes, receiving responses from the network device in response to the probes, and setting one or more thresholds for subsequent traffic destined for the network device based on the responses received from the network device.

### TECHNICAL FIELD

The present disclosure relates to mitigating denial of service attacks in an electronic communications network.

### BACKGROUND

The number of distributed denial-of-service attacks (DDoS) in computing environments has recently increased dramatically. These attacks can be difficult to mitigate because a DDoS attack originates from several sources simultaneously, flooding a targeted device with malicious or invalid packets that overwhelm the resources of the targeted device. Furthermore, as more and more appliances become IP-enabled via, e.g., relatively simple Internet of Things (IoT) devices, the success of a DDoS attack may increase in that an IoT device is often designed with limited processing and memory resources such that a DDoS attack (or a denial of service (DoS) attack) can easily reduce the availability of the IoT device to network-connected clients, or even render the IoT device inoperable for its intended function.

### BRIEF DESCRIPTION OF THE DRAWINGS

FIG. 1 depicts an electronic communications network in which threshold discovery logic can be deployed in accordance with an example embodiment.

FIG. 2 is a flow chart of one approach for automatically obtaining IoT device traffic thresholds in accordance with an example embodiment.

FIG. 3 is a flow chart of another approach for automatically obtaining IoT device traffic thresholds in accordance with an example embodiment.

FIG. 4 is a flow chart of still another approach for automatically obtaining IoT device traffic thresholds in accordance with an example embodiment.

FIG. 5 is flow chart that combines the approaches shown in FIGS. 2-4 for automatically obtaining IoT device traffic thresholds in accordance with an example embodiment.

FIG. 6 depicts a device (e.g., a firewall) on which the several described embodiments may be implemented.

### DESCRIPTION OF EXAMPLE EMBODIMENTS

### Overview

Presented herein are techniques for mitigating denial of service attacks by automatically setting appropriate thresholds for traffic destined for a network device such as an Internet of Things (IoT) device. A method includes, at a network security device, such as a firewall, monitoring network traffic, flowing through the firewall, destined for a network device, determining whether the network traffic is below a predetermined amount, while the network traffic is below the predetermined amount, sending to the network device a plurality of probes, receiving responses from the network device in response to the probes, and setting one or more thresholds for subsequent traffic destined for the network device based on the responses received from the network device.

A device or apparatus is also described. The device may be, for example, a firewall that is configured to protect the IoT device or other network device. The device includes an interface unit configured to enable network communications, a memory, and one or more processors coupled to the interface unit and the memory, and configured to: monitor network traffic, flowing through the device, destined for a network device, determine whether the network traffic is below a predetermined amount, while the network traffic is below the predetermined amount, send to the network device a plurality of probes, receive responses from the network device in response to the probes; and set one or more thresholds for subsequent traffic destined for the network device based on the responses received from the network device.

### Example Embodiments

As explained above, IoT devices can be particularly susceptible to denial of service (DoS) and Distributed DoS (DDoS) overload attacks. IoT devices are vulnerable to these attacks because IoT devices accept incoming connections from authorized clients for their operation. For example, Open Authorization (OAuth) 2.0 can be used as an authorization framework with IoT devices. In accordance with OAuth 2.0, instead of using a resource owner's credentials to access protected resources, a client obtains an access token (self-contained or handle token), which may comprise a string denoting a specific scope, lifetime and other access attributes. The access token is issued to the client by an authorization server with the approval of the resource owner. The client uses the access token to access the protected resources hosted by the resource server, i.e., a given IoT device.

An issue with using OAuth 2.0, however, is that an IoT device can be subjected to a DoS attack or DDoS attack wherein an attacker floods a given IoT device with invalid OAuth 2.0 tokens conveyed in, e.g., Constrained Application Protocol (CoAP) requests, and eventually exhausts CPU and memory resources on the IoT device. As IoT devices are resource-constrained in nature, they are even more susceptible to such access token flooding DoS or DDoS attacks.

More specifically, several different types of attacks can be mounted against an IoT device, including:

A Transmission Control Protocol (TCP) synchronization (SYN) flood attack on port 443 for CoAP over Transport Layer Security (TLS) over TCP and on port 5683 for CoAP over TCP.

An attack that exceeds the maximum number of connections that the IoT device can handle. Such an attack may be staged with valid or invalid connections, or both. In either case, this type of attack may be referred to as an “overload attack.”

A denial-of-sleep attack that drains the battery of the IoT device.

It is noted that DoS, DDoS and overload attacks on IoT devices may not require a large deviation from baseline traffic as IoT devices are configured with limited CPU, memory and power resources. As such, they can only handle a relatively small number of connections per second, a small number of maximum connections, etc.

Security devices that are deployed to protect IoT devices are not usually aware of the sustainable amount of attack traffic that an IoT device can withstand and thus, to be an effective stalwart against malicious attacks, the security device is manually configured with threshold limits of each IoT device for which it is responsible. Human intervention to manually configure threshold limits on the security device for each IoT device in a residential and small office/home office (SOHO) network is not practical and the administrator(s) in these deployments may not even be aware of the threshold limits of the IoT devices that are deployed. The same is true for an Enterprise deployment. Threshold limits that might be configured on a security device, at L3/L4 layers, could be maximum number of full connections or half-open connections, connections per second, packets per second, bytes per second, etc. and at L7 layer could be maximum requests per second, request size, etc.

The discussion below provides several mechanisms that can be employed separately or in combination to avoid the overhead of manually configuring threshold limits for IoT devices on security devices and the action(s) that security devices can automatically trigger once the threshold limit is reached. The proposed mechanisms are also useful to self-configure threshold limits for any other type of resources that can be subjected to DoS, DDoS and overload attacks.

At a high level, the embodiments described herein provide a set of mechanisms that allow security devices to self-configure threshold limits by automatically learning, using threshold discovery logic hosted on a security device, such as a firewall, IoT device capabilities so as to protect resources in the network that can be subjected to DoS, DDoS and overload attacks.

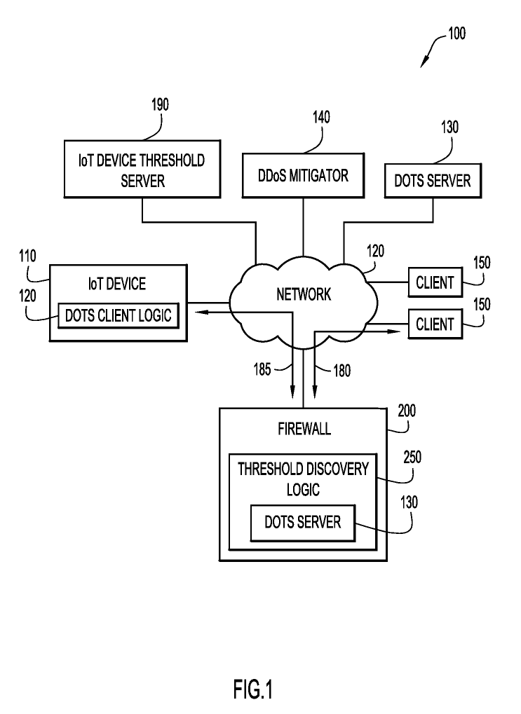

Reference is now made to FIG. 1, which depicts an electronic communications network 100 in which threshold discovery logic can be deployed in accordance with an example embodiment. Network 120, such as the Internet, or any other private or public network, interconnects several components. An IoT device 110 can communicate with, e.g., a client 150 via firewall 200. A logical communication path is shown by arrows 180, 185. Firewall 200, in the depicted embodiment, hosts threshold discovery logic 250, the function of which will be described more fully below. Those skilled in the art will appreciate that while threshold discovery logic 250 is depicted as being hosted by firewall 200, threshold discovery logic 250 may be hosted by any one of several different components in network 100.

Also shown in FIG. 1 are a Distributed Denial of Service (DDoS) Open Threat Signaling (DOTS) server 130, DDoS mitigator 140, and DOTS client 120 that may be hosted by IoT device 110. Firewall 200 may also host DOTS logic in the form of a DOTS client (not shown), and/or a DOTS server 130 or, at the very least, firewall 200 may be configured to interpret DOTS signaling, as will be described further below. As shown, DOTS server 130 hosted by firewall 200 may be part of threshold discovery logic 250. Generally, DOTS enables a given network component to ask for or request assistance from a DOTS server to mitigate a given DDoS attack. A DOTS server, upon receipt of such a request, might cause traffic destined for the given network component to be routed via a DOTS mitigator which is configured to, e.g., scrub incoming traffic and drop attack packets destined for the given network device. In the instant case, the given device might be IoT device 110, which upon detecting an attack, can employ DOTS client 120 to signal DOTS server 130, ultimately causing DDoS mitigator 140 to scrub traffic destined from IoT device 110.

Finally, FIG. 1 also shows IoT device threshold server 190 which may be configured to store threshold limits or metrics for different types of IoT devices. The use of IoT device threshold server 190 is described more fully below.

While DOTS is useful to assist an IoT device in the midst of a DDoS crisis, it may be more useful to try to keep the IoT device from entering such a crisis mode in the first place. In this regard, a security device protecting IoT device 110, such as firewall 200, should be aware of the threshold limits of each IoT device that it is trying to protect. Given the heterogeneous mix of IoT devices in the marketplace and deployed across the Internet landscape, it would be desirable for firewall 200 to have the capability to learn the limits of each IoT device in the network. In accordance with the embodiments described herein, these limits can be discovered using an advertisement/capability exchange protocol or by probing the IoT device by testing its limits during network silence. The firewall 200 can then be automatically configured with the discovered threshold limits and subsequently protect the IoT device from (D)DoS and overload attacks. The operation of manually configuring a firewall is often quite burdensome. The embodiments described herein, however, help alleviate the configuration burden that might normally fall to a network administrator.

### Threshold Limits Discovery Using a Protocol

In one embodiment, each IoT device may be configured at time of manufacture or in a separate configuration stage thereafter, to be able to advertise its own threshold limits or metrics to a network device, e.g., firewall 200, with which it is in communication. For example, the Manufacturer Usage Description (MUD) Framework (Network Working Group, Internet-Draft) could be modified to include an extension to include threshold limits of the IoT device upon power up or upon network connection. That is, the threshold limits could be provided to firewall 200 via a protocol compliant with MUD.

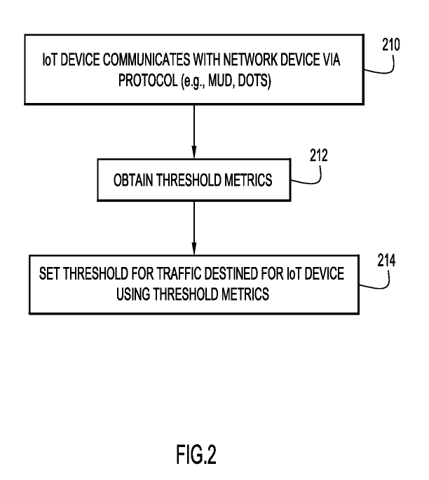

FIG. 2 is a flow chart of the foregoing protocol approach for automatically obtaining IoT device thresholds in accordance with an example embodiment. At 210, IoT device 110 communicates with a network device, such as firewall 200 (using threshold discovery logic 250) via a protocol such as MUD. Using that protocol, at 212, the firewall obtains one or more threshold metrics or limits. At 214, using the threshold metrics or limits, one or more thresholds are set for traffic destined for the IoT device.

Those skilled in the art will appreciate that it is quite possible that not all manufacturers of IoT devices will adopt the use of a standard protocol to be used to enable discovery of threshold metrics. Thus, another embodiment leverages the use of DOTS. More specifically, if the IoT device is DOTS capable, i.e., the IoT device includes DOTS client logic 120 that is configured to request attack response coordination with other DOTS-aware elements, e.g., DOTS server 130 hosted by firewall 200, the IoT device could signal its need for DDoS attack mitigation, and also simultaneously send its threshold limits, using the DOTS signaling channel to the DOTS server 130 (on firewall 200). When the attack rate falls below the threshold limits conveyed by the DOTS client logic 120, then the DOTS server 130 may inform the DOTS logic client 120 that the attack has stopped, and the DOTS logic client 120 can withdraw the mitigation request and handle the attack on its own. Thus, the DOTS protocol is another avenue by which an IoT device might advertise its threshold limits to a security device.

With reference again to FIG. 2, operation 210 indicates, as protocol threshold discovery examples, both the MUD protocol and DOTS. In sum, where the IoT device is configured to proactively provide threshold limits to its security device (e.g., firewall 200), the security device can quickly learn the thresholds and set traffic limits (one or more thresholds) for the IoT device accordingly.

It is possible, of course, that neither a particular protocol has been leveraged to discover threshold limits or that DOTS has been leveraged to supply threshold limits to the security device. Where the firewall cannot obtain device capabilities (threshold limits/metrics) using the foregoing protocol approaches, the firewall may employ pre-configured default settings (thresholds) and may still further proceed in accordance with one of the mechanisms described below to discover more accurate thresholds for respective IoT devices.

### Threshold Limits Discovery Using Probes

In this embodiment, firewall 200, via threshold discovery logic 250, is configured to probe IoT device 110 to iteratively learn the IoT device's capabilities (threshold limits/metrics) such as TCP and UDP connection limits, packet size limits, etc. Since firewall 200 monitors all traffic going to IoT device 110 (via 180, 185), firewall 200 is aware when there is no traffic to/from IoT device 110. Firewall 200 can use this window of low or zero traffic exchange to run its own probes and tests to heuristically determine threshold limits of IoT device 110. That is, threshold discovery logic 250 may be configured to send increasing amounts of traffic, connection requests, etc. and discover, by monitoring response latency, for example, whether the resources of IoT device 110 are becoming strained. Using a window where traffic is below a predetermined amount provides greater confidence that the detected latency is a result of the probes being sent.

In this way, firewall 200 can effectively monitor the CPU and memory utilization of IoT device 110 to identify the threshold limits and/or the delay in the responses from the IoT device as the probe rate increases to estimate the threshold limit. Firewall 200 can also detect when an IoT device switches to, e.g., SYN Cookie mode by observing how the SYN queue is filled up (which is observable because TCP options are discarded). Such a mode change is indicative of low memory, and thus indicative that the resources of IoT device 110 are being strained.

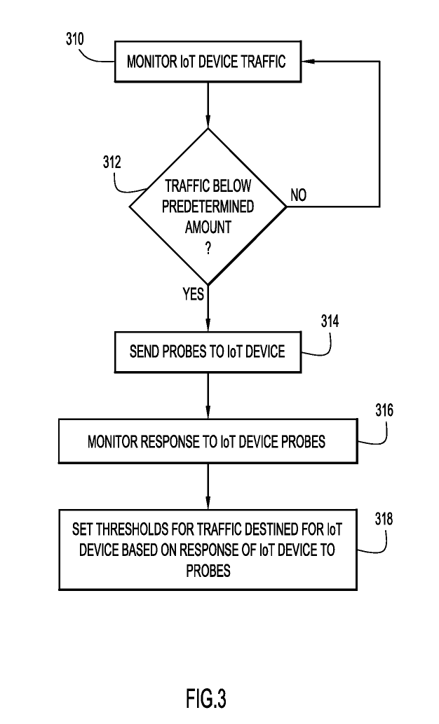

FIG. 3 is a flow chart of the foregoing probing approach for automatically obtaining IoT device traffic thresholds in accordance with an example embodiment. The following operations may be considered to be performed by threshold discovery logic 250 in coordination with firewall 200. At 310, IoT device traffic (i.e., network traffic associated with the IoT device) is monitored. At 312, it is determined if the traffic being sent to/from the IoT device is below a predetermined amount. If not, operation 310 is repeated. In other words, operation 312 ensures that probing occurs substantially only when there is very little to no traffic destined for, or coming from, the IoT device.

If it is determined that there is a window of low activity at 312, at 314 probes are sent to the IoT device. The probes may be configured to set up new connections, or to request data over a previously established connection. The frequency of the probes may be increased over time to achieve the desired effect of challenging the IoT device such that relevant thresholds can be discovered. In this regard, at 316, responses to the IoT device probes are monitored. When, for example, response time begins to increase, this could be indicative that the resources of the IoT device are beginning to be stained, which is indicative that the IoT device is approaching a threshold limit. At 318, one or more thresholds for traffic destined for the IoT device are then set based on the response to the probes. That is, firewall 200, for example, sets one or more thresholds to govern and/or throttle the amount and type of traffic that can reach the IoT device.

Thus, a goal of the described approach is to determine and extrapolate threshold limits with basic probing, generating normal traffic and gradually increasing the traffic rate. The probing is stopped if monitored responses from the device are delayed. Subjecting the IoT device to abnormal traffic could have adverse effects on the device, e.g., a sensitive medical device. Consequently, determining increase in latency as a consequence gradual increase in packets per second/bytes per second/open connections, etc. could give a fair indication of threshold. In this regard, statistical (e.g., average, median, etc.) limits may be employed to determine threshold limits. Another way to determine a threshold is to determine, through probing, what “normal” traffic might be, and then set a threshold at, e.g., 120% of that “normal” traffic. Once that threshold is met, packets can be dropped, or DOTS signaling can be initiated, thus keeping the IoT device from crashing.

A firewall can also learn the identity (and other characteristics) of an IoT device it protects by inspecting the traffic from the IoT device (for example, sensor information could be signaled in SenML format in HTTP). Although the limits learned may not be fully accurate, such limits can nevertheless help to obtain thresholds that are more accurate than pre-configured default thresholds, and can facilitate the automation of threshold setting.

Moreover, the firewall can then upload the threshold limits of the IoT device, IoT device type, etc. to a cloud repository, e.g., IoT device threshold server 190, so that firewalls in other networks can query and learn the threshold limits for similar types of IoT devices. Such updating of IoT device threshold server 190 has the effect of building an accurate database that can also be leverage to help detect and predict attacks The resulting database in the cloud can help firewalls in different administrative domains to cross-check their threshold limit results and normalize.

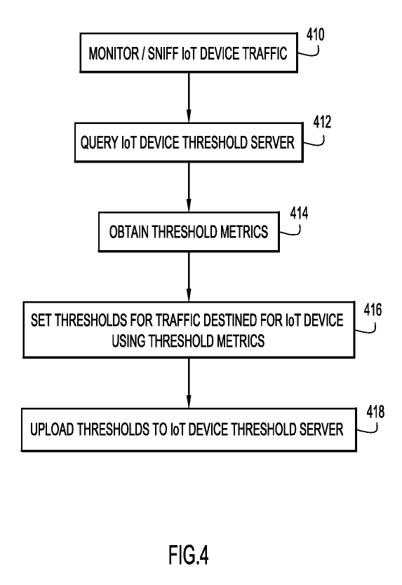

FIG. 4 is a flow chart of the foregoing inspection or “sniffing” approach for automatically obtaining IoT device traffic thresholds in accordance with an example embodiment. At 410, IoT device traffic is monitored or sniffed. At 412, an IoT device threshold server can be queried to determine if an entry for the monitored type of IoT device is available. At 414, either in response to a response from the IoT device threshold server, or based on the traffic that has been monitored, threshold metrics/limits are discovered/obtained. At 416, thresholds for traffic destined for the IoT device are set using the threshold metrics/limits.

Finally, at 418, thresholds that are discovered based on the monitored traffic, can then be uploaded to the IoT device threshold server for other firewalls to query.

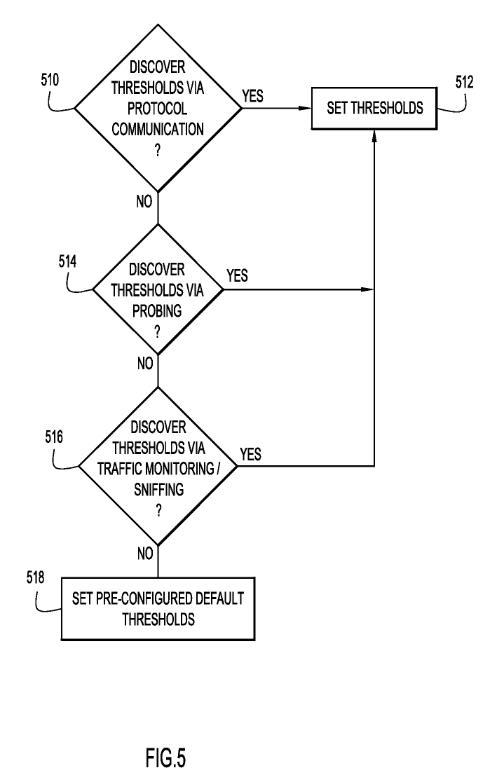

FIG. 5 is flow chart that combines the approaches shown in FIGS. 2-4 for automatically obtaining IoT device traffic thresholds in accordance with an example embodiment. At 510, it is determined whether thresholds are discovered via protocol communications (e.g., MUD or DOTS). If yes, then at 512, thresholds in firewall 200 are set in accordance with the protocol-obtained thresholds. If protocols are not available to discover the thresholds, then at 514, thresholds may be discovered via probing. If thresholds are discovered via probing, then one or more thresholds are set in firewall 200 at 512. If thresholds cannot be discovered via probing, then it is determined whether thresholds may be discovered via traffic monitoring or sniffing at 516. If thresholds can be discovered via traffic monitoring or sniffing either directly from such monitoring or sniffing, or via a query to a threshold server, then those thresholds are used to set one or more thresholds in firewall 200. If thresholds cannot be discovered via traffic monitoring or sniffing, then at 518 the firewall is set with one or more preconfigured default thresholds.

Those skilled in the art will appreciate that although FIG. 5 implies using only one type of threshold discovery approach at a time, it is also contemplated to employ each or all of the discovery approaches as a backup to, confirmation of, or augmentation to thresholds discovered via any one of the approaches.

Once the threshold limit for an IoT device is reached, the firewall can either act as a DDoS mitigator to scrub and drop the attack traffic or act as a DOTS client and signal the DOTS server (e.g., standalone DOTS server 130, FIG. 1) to request mitigation of the attack. DOTS server 130 in-turn instructs the DDoS mitigator 140 to scrub incoming traffic destined for the IoT device. DDoS mitigator 140 may use signatures, machine learning techniques etc. to detect and block attack traffic. If the IoT device is not subjected to a DoS or DDoS attack, but is subjected to an overload attack, then firewall 200 can react accordingly by, for example, rate-limiting or dropping incoming traffic destined for the IoT device, or act as a reverse-proxy, among other possible remediation techniques. That is, the firewall can act as a reverse-proxy for the IoT device such that clients communicate with the firewall and send requests to the firewall, the firewall discards bad traffic from attackers, forwards legitimate traffic to the IoT device, and the firewall may cache the responses from the IoT device and respond on behalf of the IoT device to clients.

In sum, the embodiments described herein provide mechanisms to avoid the overhead of manually configuring threshold limits for IoT devices on security devices and the action(s) the security device can automatically trigger once the threshold limit is reached. A significant advantage of such embodiments is self-configuration of threshold limits for IoT devices on security devices.

Those skilled in the art will appreciate the IoT devices being protected in accordance with the embodiments described herein are relatively simple devices, and once impacted by a DoS, DDoS or overload/exhaustion attack might not be able to easily or readily recover. It is precisely because of the relative frailty of IoT devices that the instant embodiments can have a very useful effect. The threshold discovery and subsequent threshold setting proactively prevent a given IoT device from being overwhelmed with attack traffic.

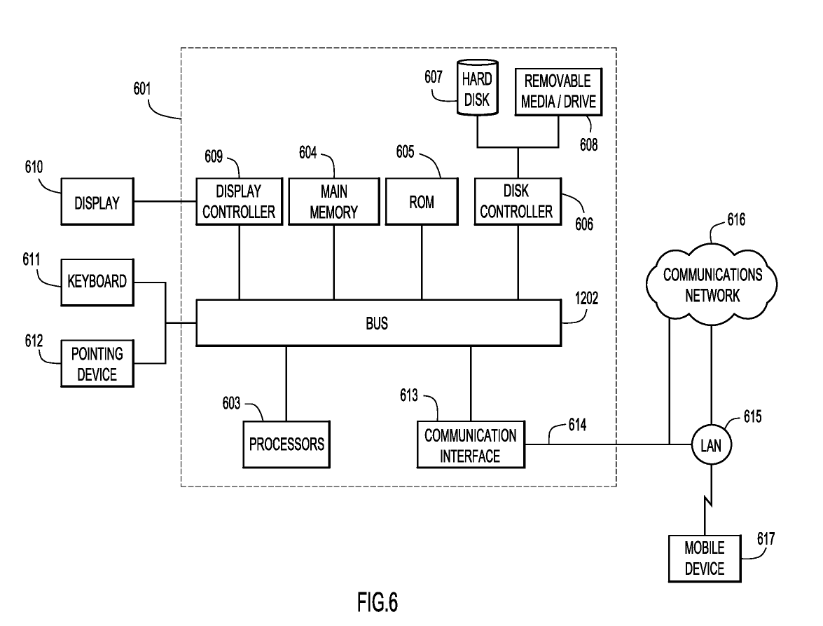

FIG. 6 depicts a device (e.g., firewall 200) on which the several described embodiments may be implemented. The apparatus may be implemented on or as a computer system 601. The computer system 601 may be programmed to implement a computer based device. The computer system 601 includes a bus 602 or other communication mechanism for communicating information, and a processor 603 coupled with the bus 602 for processing the information. While the figure shows a single block 603 for a processor, it should be understood that the processor 603 represents a plurality of processors or processing cores, each of which can perform separate processing. The computer system 601 may also include a main memory 604, such as a random access memory (RAM) or other dynamic storage device (e.g., dynamic RAM (DRAM), static RAM (SRAM), and synchronous DRAM (SD RAM)), coupled to the bus 602 for storing information and instructions (e.g., threshold discovery logic 250 to perform the operations described throughout) to be executed by processor 603. In addition, the main memory 604 may be used for storing temporary variables or other intermediate information during the execution of instructions by the processor 603.

The computer system 601 may further include a read only memory (ROM) 605 or other static storage device (e.g., programmable ROM (PROM), erasable PROM (EPROM), and electrically erasable PROM (EEPROM)) coupled to the bus 602 for storing static information and instructions for the processor 603.

The computer system 601 may also include a disk controller 606 coupled to the bus 602 to control one or more storage devices for storing information and instructions, such as a magnetic hard disk 607, and a removable media drive 608 (e.g., floppy disk drive, read-only compact disc drive, read/write compact disc drive, compact disc jukebox, tape drive, and removable magneto-optical drive). The storage devices may be added to the computer system 601 using an appropriate device interface (e.g., small computer system interface (SCSI), integrated device electronics (IDE), enhanced-IDE (E-IDE), direct memory access (DMA), or ultra-DMA).

The computer system 601 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)), that, in addition to microprocessors and digital signal processors may individually, or collectively, are types of processing circuitry. The processing circuitry may be located in one device or distributed across multiple devices.

The computer system 601 may also include a display controller 609 coupled to the bus 602 to control a display 610, such as a cathode ray tube (CRT) or liquid crystal display (LCD), for displaying information to a computer user. The computer system 601 may include input devices, such as a keyboard 611 and a pointing device 612, for interacting with a computer user and providing information to the processor 603. The pointing device 612, for example, may be a mouse, a trackball, or a pointing stick for communicating direction information and command selections to the processor 603 and for controlling cursor movement on the display 610. In addition, a printer may provide printed listings of data stored and/or generated by the computer system 601.

The computer system 601 performs a portion or all of the processing operations of the embodiments described herein in response to the processor 603 executing one or more sequences of one or more instructions contained in a memory, such as the main memory 604. Such instructions may be read into the main memory 604 from another computer readable medium, such as a hard disk 607 or a removable media drive 608. One or more processors in a multi-processing arrangement may also be employed to execute the sequences of instructions contained in main memory 604. In alternative embodiments, hard-wired circuitry may be used in place of or in combination with software instructions. Thus, embodiments are not limited to any specific combination of hardware circuitry and software.

As stated above, the computer system 601 includes at least one computer readable medium or memory for holding instructions programmed according to the embodiments presented, for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SD RAM, or any other magnetic medium, compact discs (e.g., CD-ROM), or any other optical medium, punch cards, paper tape, or other physical medium with patterns of holes, or any other medium from which a computer can read.

Stored on any one or on a combination of non-transitory computer readable storage media, embodiments presented herein include software for controlling the computer system 601, for driving a device or devices for implementing the described embodiments, and for enabling the computer system 601 to interact with a human user. Such software may include, but is not limited to, device drivers, operating systems, development tools, and applications software. Such computer readable storage media further includes a computer program product for performing all or a portion (if processing is distributed) of the processing presented herein.

The computer code may be any interpretable or executable code mechanism, including but not limited to scripts, interpretable programs, dynamic link libraries (DLLs), Java classes, and complete executable programs. Moreover, parts of the processing may be distributed for better performance, reliability, and/or cost.

The computer system 601 also includes a communication interface 613 coupled to the bus 602. The communication interface 613 provides a two-way data communication coupling to a network link 614 that is connected to, for example, a local area network (LAN) 615, or to another communications network 616. For example, the communication interface 613 may be a wired or wireless network interface card or modem (e.g., with SIM card) configured to attach to any packet switched (wired or wireless) LAN or WWAN. As another example, the communication interface 613 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 613 sends and receives electrical, electromagnetic or optical signals that carry digital data streams representing various types of information.

The network link 614 typically provides data communication through one or more networks to other data devices. For example, the network link 614 may provide a connection to another computer through a local are network 615 (e.g., a LAN) or through equipment operated by a service provider, which provides communication services through a communications network 616. The local network 614 and the communications network 616 use, for example, electrical, electromagnetic, or optical signals that carry digital data streams, and the associated physical layer (e.g., CAT 5 cable, coaxial cable, optical fiber, etc.). The signals through the various networks and the signals on the network link 614 and through the communication interface 613, which carry the digital data to and from the computer system 601 may be implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 601 can transmit and receive data, including program code, through the network(s) 615 and 616, the network link 614 and the communication interface 613. Moreover, the network link 614 may provide a connection to a mobile device 617 such as a personal digital assistant (PDA) laptop computer, cellular telephone, or modem and SIM card integrated with a given device.

In summary, in one form, a method is provided. The method includes: at a network security device: monitoring network traffic, flowing through the network security device, destined for a network device, determining whether the network traffic is below a predetermined amount, while the network traffic is below the predetermined amount, sending to the network device a plurality of probes, receiving responses from the network device in response to the probes, and setting one or more thresholds for subsequent traffic destined for the network device based on the responses received from the network device.

In one implementation setting thresholds for subsequent traffic destined for the network device based on the responses received from the network device comprises setting the one or more thresholds based on a latency of the responses.

The thresholds may include at least one of a maximum number of connections, maximum number of half-open connections, maximum number of connections per unit of time, maximum number of half-open connections per unit of time, maximum number of packets per unit of time, maximum number of bytes per unit of time, maximum number of requests per unit of time, or maximum size of a request.

In accordance with an embodiment, the network device is an Internet of Things (IoT) device, and the network security device is a firewall, the method further includes operating a Distributed Denial of Service (DDoS) Open Threat Signaling (DOTS) client on the firewall and signaling a DOTS server to help mediate a DDoS attack against the IoT device.

The method still further include detecting whether the network device has switched to a synchronization (SYN) cookie mode as an indicator that the network device is approaching a connection threshold limit.

The method, in one possible implementation, further includes determining that the thresholds cannot be obtained via a predetermined protocol configured to advertise the thresholds by the network device. The predetermined protocol may be one of the Manufacturer Usage Description (MUD) protocol or the Distributed Denial of Service (DDoS) Open Threat Signaling (DOTS) protocol.

The method may still also include discovering the thresholds by sniffing the network traffic, and uploading the thresholds to a (device threshold) server that is accessible to other network security devices. Finally, it is possible to query a (device threshold) server with an indication of a type of the network device to obtain thresholds for the type of the network device.

In another form, a device is provided that comprises an interface unit configured to enable network communications, a memory, and one or more processors coupled to the interface unit and the memory, and configured to: monitor network traffic, flowing through the device, destined for a network device, determine whether the network traffic is below a predetermined amount, while the network traffic is below the predetermined amount, send to the network device a plurality of probes, receive responses from the network device in response to the probes, and set one or more thresholds for subsequent traffic destined for the network device based on the responses received from the network device.

In yet another form, one or more non-transitory computer readable storage media encoded with software comprising computer executable instructions and when the software is executed operable to: monitor network traffic, flowing through a network security device, destined for a network device, determine whether the network traffic is below a predetermined amount, while the network traffic is below the predetermined amount, send to the network device a plurality of probes, receive responses from the network device in response to the probes, and set one or more thresholds for subsequent traffic destined for the network device based on the responses received from the network device.

The above description is intended by way of example only. Various modifications and structural changes may be made therein without departing from the scope of the concepts described herein and within the scope and range of equivalents of the claims.

What is claimed is:

1. A method comprising:
at a network security device:
monitoring network traffic, flowing through the network security device, destined for a network device;
determining whether the network traffic is below a predetermined amount;
while the network traffic is below the predetermined amount, sending to the network device a plurality of probes;
receiving responses from the network device in response to the probes; and
setting one or more thresholds for subsequent traffic destined for the network device based on the responses received from the network device.

2. The method of claim 1, wherein setting one or more thresholds for subsequent traffic destined for the network device based on the responses received from the network device comprises setting the one or more thresholds based on a latency of the responses.

3. The method of claim 1, wherein the one or more thresholds comprise at least one of a maximum number of connections, maximum number of half-open connections, maximum number of connections per unit of time, maximum number of half-open connections per unit of time, maximum number of packets per unit of time, maximum number of bytes per unit of time, maximum number of requests per unit of time, or maximum size of a request.

4. The method of claim 1, wherein the network device is an Internet of Things (IoT) device, and the network security device is a firewall, the method further comprising operating a distributed denial of service (DDoS) Open Threat Signaling (DOTS) client on the firewall and signaling a DOTS server to mediate a DDoS attack against the IoT device.

5. The method of claim 1, further comprising detecting whether the network device has switched to a synchronization (SYN) cookie mode as an indicator that the network device is approaching a connection threshold limit.

6. The method of claim 1, wherein further comprising determining that the one or more thresholds cannot be obtained via a predetermined protocol configured to advertise the one or more thresholds by the network device.

7. The method of claim 6, wherein the predetermined protocol is one of the Manufacturer Usage Description (MUD) protocol or the Distributed Denial of Service (DDoS) Open Threat Signaling (DOTS) protocol.

8. The method of claim 1, further comprising discovering the one or more thresholds by sniffing the network traffic.

9. The method of claim 8, further comprising uploading the one or more thresholds to a server that is accessible to other network security devices.

10. The method of claim 1, further comprising querying a server with an indicator of a type of the network device to obtain a threshold based on the type of the network device.

11. A device comprising:
an interface unit configured to enable network communications;
a memory; and
one or more processors coupled to the interface unit and the memory, and configured to:
monitor network traffic, flowing through the device, destined for a network device;
determine whether the network traffic is below a predetermined amount;
while the network traffic is below the predetermined amount, send to the network device a plurality of probes;
receive responses from the network device in response to the probes; and
set one or more thresholds for subsequent traffic destined for the network device based on the responses received from the network device.

12. The device of claim 11, wherein the one or more processors are configured to set one or more thresholds for subsequent traffic destined for the network device based on the responses received from the network device by setting the one or more thresholds based on a latency of the responses.

13. The device of claim 11, wherein the one or more thresholds comprise maximum number of connections, maximum number of packets per unit of time, maximum number of bytes per unit of time, maximum number of requests per unit of time, or maximum size of a request.

14. The device of claim 11, wherein the network device is an Internet of Things (IoT) device, and the device is a firewall, and wherein the one or more processors are configured to operate a Distributed Denial of Service (DDoS) Open Threat Signaling (DOTS) client on the firewall and signal a DOTS server to mediate a DDoS attack against the network device.

15. The method of claim 1, wherein the one or more processors are configured to detect whether the network device has switched to a synchronization (SYN) cookie mode as an indicator that the network device is approaching a connection threshold limit.

16. One or more non-transitory computer readable storage media encoded with software comprising computer executable instructions and when the software is executed operable to:
monitor network traffic, flowing through a network security device, destined for a network device;
determine whether the network traffic is below a predetermined amount;
while the network traffic is below the predetermined amount, send to the network device a plurality of probes;
receive responses from the network device in response to the probes; and
set one or more thresholds for subsequent traffic destined for the network device based on the responses received from the network device.

17. The non-transitory computer readable storage media of claim 16, wherein the instructions further comprise instructions operable to set one or more thresholds for subsequent traffic destined for the network device based on the responses received from the network device by setting the one or more thresholds based on a latency of the responses.

18. The non-transitory computer readable storage media of claim 16, wherein the one or more thresholds comprise maximum number of connections, maximum number of packets per unit of time, maximum number of bytes per unit of time, maximum number of requests per unit of time, or maximum size of a request.

19. The non-transitory computer readable storage media of claim 16, wherein the instructions further comprise instructions operable to operate a Distributed Denial of Service (DDoS) Open Threat Signaling (DOTS) client and signal a DOTS server to mediate a DDoS attack against the network device.

20. The non-transitory computer readable storage media of claim 16, wherein the instructions further comprise instructions operable to detect whether the network device has switched to a synchronization (SYN) cookie mode as an indicator that the network device is approaching a connection threshold limit.
